(19) United States
(12) Patent Application Publication
(10) Pub. No.: US 2002/0162604 A1
(43) Pub. Date: Nov. 7, 2002

(54) Laser cutting method and apparatus with a bifocal optical means and a hydrogen-based assist gas

(76) Inventor: Olivier Matile, Paris (FR)

Correspondence Address: YOUNG & THOMPSON, 745 SOUTH 23RD STREET 2ND FLOOR, ARLINGTON, VA, 22202

(21) Appl. No.: 10/077,950

(22) Filed: Feb. 20, 2002

(30) Foreign Application Priority Data
Mar. 9, 2001 (FR) 0103265

(51) Int. Cl. B23K 7/00

(52) U.S. Cl. 148/194; 266/48

(57) ABSTRACT

Apparatus and method for cutting a workpiece by the use of a laser beam and an assist gas, in which at least one optical means is used to focus the laser beam at several focal points separate from one another, and in which, as assist gas for the said laser beam, a gas mixture containing hydrogen and at least one inert gas is used. The optical means is transparent or reflecting and is chosen from lenses, mirrors and combinations thereof, preferably a bifocal lens. The workpiece to be cut is made of stainless steel, coated steel, aluminum or an aluminum alloy, non-alloy steel or alloy steel. The inert gas is chosen from nitrogen, argon, helium and mixtures thereof.

The present invention relates to a method of cutting stainless steels, coated steels, aluminium and its alloys, non-alloy steels, alloy steels and high-alloy steels, whether they be ferritic or austenitic, by laser beam using a lens or a mirror having several focal points, to focus the laser beam at least two points which are separate from one another and preferably lie on the same axis, and a mixture of hydrogen and at least one inert component, such as nitrogen, as assist gas for the laser beam.

Stainless steels, coated steels, aluminium and aluminium alloys, non-alloy steels, alloy steels and high-alloy steels, whether they be ferritic or austenitic, are especially cut by using a laser beam and nitrogen or oxygen as assist gas for the laser beam, that is to say as cutting gas.

Moreover, it is known that the use of nitrogen as cutting gas for these materials results in cutting speeds which are considerably less than those obtained with oxygen, typically 30 to 60% less, and in high gas consumption, typically 30 to 600% greater depending on the material in question.

It has been shown moreover, especially by document EP-A-655 021, that nitrogen/hydrogen mixtures make it possible to increase the cutting speed when laser cutting workpieces to be machined in the form of strip or plate, especially in the form of sheet.

In other words, it is known to use mixtures of the nitrogen/hydrogen type instead of nitrogen so as to improve the performance of the laser cutting method compared with laser cutting using pure nitrogen.

Moreover, document EP-A-886 555 proposes the use of nitrogen/hydrogen or argon/hydrogen mixtures for laser cutting at speeds of less than 10 m/min.

The problem that arises from the above is how to further improve the methods for laser beam cutting of stainless steels, coated steels, aluminium and aluminium alloys, non-alloy steels, alloy steels and high-alloy steels, whether they be ferritic or austenitic, so as to increase the cutting speed by at least 30 to 40% compared with a laser cutting method using pure nitrogen and by at least 20% compared with a laser cutting method using a nitrogen/hydrogen mixture, all other conditions being equal.

In addition, a further object of the invention is to increase the performance of laser cutting methods, but while controlling, or even reducing the amounts of assist gas consumed, and do so in particular for the purpose of optimizing the overall costs of the industrial cutting method used.

In other words, the object of the invention is therefore to provide a laser cutting method which makes it possible to increase the cutting performance and to limit the consumption of cutting gas.

The present invention therefore relates to a method for cutting a workpiece by using a laser beam and an assist gas, in which at least one optical means is used to focus the laser beam at several focal points, separate from one another, and in which, as assist gas for the said laser beam, a gas mixture containing hydrogen and at least one inert gas is used.

Depending on the case, the method of the invention may include one or more of the following features:

the optical means of the multifocus type is chosen from lenses, mirrors and combinations thereof, preferably a bifocal lens, that is to say one which focuses the beam at two focal points separate from each other. More generally, in the case of the present invention, the term “optical means of the multifocus type” is understood to mean an optical means allowing the laser beam to be focused at several focal points separate from one another, usually a first and a second focal point, which lie separately on an axis approximately coaxial with the axis of the nozzle of the laser device, that is to say of the laser head which emits the laser beam or beams. Such an optical means and its use in laser cutting are described in document EP-A-929 376;

the workpiece to be cut is chosen from plate, sheet and tube;

the optical means is transparent or reflecting and is chosen from lenses, mirrors and combinations thereof, preferably a bifocal lens;

the workpiece to be cut is made of stainless steel, coated steel, aluminium or aluminium alloy, non-alloy steel or alloy steel;

the inert gas is chosen from nitrogen, argon, helium and mixtures thereof, preferably the inert gas being chosen from nitrogen, argon and mixtures thereof;

the assist gas contains from 150 ppm by volume to 40% by volume of hydrogen, preferably from 0.5% by volume to 30% by volume of hydrogen, the balance being the inert gas;

the assist gas consists of 5% by volume to 30% by volume of hydrogen, the balance being nitrogen;

the thickness of the workpiece to be cut is between 0.2 mm and 20 mm, typically between 0.3 mm and 16 mm;

the cutting speed is between 0.5 m/min and 20 m/min;

the optical means is arranged so as to obtain at least one first focal point positioned near the upper surface of the workpiece to be cut, preferably so as to coincide with the said upper surface, or in the thickness of the workpiece to be cut in a region close to the said upper surface, and at least one second focal point positioned near the lower surface of the workpiece to be cut and in the thickness of the latter, or outside the latter;

the assist gas contains hydrogen in an amount adjusted according to the thickness and/or the constituent material of the workpiece to be cut.

The invention also relates to a laser beam cutting apparatus for implementing a method according to the invention, comprising:

at least one laser generator for generating at least one laser beam;

at least one cutting nozzle with at least one laser beam inlet and at least one laser beam outlet;

at least one transparent or reflecting optical means of the multifocus type for focusing the said laser beam at several focal points; and

at least one source of assist gas containing hydrogen and at least one inert gas for the said laser beam and for feeding the said nozzle with the said assist gas.

Alternatively, the laser beam cutting apparatus for implementing a method according to the invention comprising:

at least one laser generator for generating at least one laser beam;

at least one cutting nozzle with at least one laser beam inlet and at least one laser beam outlet;

at least one transparent or reflecting optical means of the multifocus type for focusing the said laser beam at several focal points;

at least a first source of gas containing at least hydrogen;

at least a second source of gas containing at least one inert gas; and

gas mixing means for mixing the gas coming from the first gas source with gas coming from the second gas source so as to obtain an assist gas for the said laser beam containing hydrogen and at least one inert gas, the said assist gas feeding the said nozzle.

The invention relies on the use, in combination, on the one hand, of one or more transparent or reflecting optical components, such as lenses or mirrors, in order to obtain several separate focal points (FP1, FP2, etc.) for the laser beam, lying approximately along the same axis and, on the other hand, of a mixture containing hydrogen and one or more inert gas components, particularly nitrogen, argon or mixtures of these components, as assist gas, that is to say as cutting gas.

A cutting apparatus that can be used to implement the invention comprises, for example, a laser generator of the CO₂ type for generating the laser beam, an output nozzle through which the laser beam passes, at least one transparent or reflecting optical means for focusing the said laser beam and a source of assist gas for the laser beam, feeding the output nozzle with with assist gas, the assist gas being introduced into the nozzle by, for example, one or more gas inlets passing through the peripheral wall of the nozzle. However, the laser may be of the Nd:YAG type.

According to the invention, a laser having a power of 500 to 6000 W is used.

The optical means is of the multifocus type, preferably a bifocal lens, and the source of assist gas feeds the nozzle with an assist gas mixture containing hydrogen and at least one inert gas.

Transparent or reflecting optical components of this type, that is to say those having several focal points, which can be used within the context of the present invention are described in document EP-A-929 376, to which reference may be made for further details.

The principle of operation of a multifocus optical means is outlined below.

A first focal point FP1 coming from the largest angle of convergence obtained with the said multifocus optical means lies near the upper surface of the workpiece to be cut, preferably so as to coincide with the said upper surface, or in the thickness of the material in a region close to the said upper surface.

Moreover, a second focal point FP2 coming from the smallest angle of convergence obtained with the said multifocus optical means lies near the lower surface of the workpiece in the thickness of the material, or outside it.

This principle makes it possible, compared with the use of a standard optical component, to use smaller nozzle diameters and therefore to decrease the gas consumption, since such a standard optical component, that is to say one having only a single focal point, means positioning its single focal point, for which the angle of convergence is the largest, at the lower face of the material, or indeed below it, and, consequently, in order to allow the laser beam through, it is necessary to use large-diameter nozzles, which correspondingly increases the gas consumption.

### COMPARATIVE EXAMPLES

To illustrate the invention, comparative trials were carried out and the results of these trials, in terms of cutting speed, are given in the table below.

A 3 mm thick stainless steel plate was cut with a CO₂ laser having a power of 1500 W, using either pure nitrogen (Trial 1) or a gas mixture containing 25 vol. % H₂, and nitrogen for the balance, and this was done firstly, with a standard lens (Trial 2), that is to say one having a single focal point, and, secondly, with a bifocal lens (Trial 3), all other operating conditions being equal.

Comparative Table

| | Trial 1 | Trial 2 | Trial 3 |
|---|---|---|---|
| | (prior art) | (prior art) | (invention) |
| Cutting gas | Pure N₂ | N₂ + 25% H₂ | N₂ + 25% H₂ |
| Optical | Conventional | Conventional | Bifocal lens |
| component | monofocal lens | monofocal lens | |
| Cutting speed | 2.2 m/min | 2.5 m/min | 3.2 m/min |
| Gas consumption | 15 m³/h | 15 m³/h | 10 m³/h |

As may be seen in the table, Trial 3 according to the invention results in markedly higher cutting speeds than those obtained with the conventional methods (Trials 1 and 2), thanks to the use, in combination, of a bifocal lens and an N₂/H₂ mixture, the H₂ content of which was carefully controlled. The same applies to the saving in gas consumption.

This is because the method of the invention makes it possible to increase the cutting speed, under the conditions of the above trials, by more than 40% with respect to a method using a standard lens and pure nitrogen (Trial 1), and by more than 20% compared with a method using a standard lens and a nitrogen/hydrogen mixture (Trial 2).

In addition, it is also apparent from these trials that Trial 3 is the one allowing the greatest saving of gas to be made.

The proportion of H₂ to be used is controlled or adjusted according to various operating parameters, such as the nature and/or the thickness of the material to be cut, especially for the purpose of avoiding the formation of flash adhering to the bottom of the kerf and/or the oxidation of the cutting faces by oxygen or atmospheric air.

Preferably, the H₂ contents are from 5% to 30% by volume, the balance being nitrogen.

It is also conceivable to use argon instead of nitrogen, and Ar+N₂+H₂ mixtures.

In summary, the use of a laser cutting method according to the invention results in high cutting speeds, that is to say those ranging from about 0.5 m/min to about 12 m/min, depending on the thicknesses and on the material to be cut, combined with low cutting gas flow rates, typically no more than 350 m³/h, and the production of high-quality low-cost cut workpieces, in particular with a laser source having a power of 1800 watts for example.

1. Method for cutting a workpiece by using a laser beam and an assist gas, in which at least one optical means is used to focus the laser beam at several focal points, separate from one another, and in which, as assist gas for the said laser beam, a gas mixture containing hydrogen and at least one inert gas is used.

2. Method according to claim 1, characterized in that the optical means is transparent or reflecting and is chosen from lenses, mirrors and combinations thereof, preferably a bifocal lens.

3. Method according to either of claims 1 and 2, characterized in that the workpiece to be cut is made of stainless steel, coated steel, aluminium or aluminium alloy, non-alloy steel or alloy steel.

4. Method according to one of claims 1 to 3, characterized in that the inert gas is chosen from nitrogen, argon, helium and mixtures thereof, preferably the inert gas being chosen from nitrogen, argon and mixtures thereof.

5. Method according to one of claims 1 to 4, characterized in that the assist gas contains from 150 ppm by volume to 40% by volume of hydrogen, preferably from 0.5% by volume to 30% by volume of hydrogen, the balance being the inert gas.

6. Method according to one of claims 1 to 5, characterized in that the assist gas consists of 5% by volume to 30% by volume of hydrogen, the balance being nitrogen.

7. Method according to one of claims 1 to 6, characterized in that the thickness of the workpiece to be cut is between 0.2 mm and 20 mm, typically between 0.3 mm and 16 mm.

8. Method according to one of claims 1 to 7, characterized in that the cutting speed is between 0.5 m/min and 20 m/min.

9. Method according to one of claims 1 to 8, characterized in that the optical means is arranged so as to obtain at least one first focal point positioned near the upper surface of the workpiece to be cut, preferably so as to coincide with the said upper surface, or in the thickness of the workpiece to be cut in a region close to the said upper surface, and at least one second focal point positioned near the lower surface of the workpiece to be cut and in the thickness of the latter, or outside the latter.

10. Method according to one of claims 1 to 9, characterized in that the assist gas contains hydrogen in an amount adjusted according to the thickness and/or the constituent material of the workpiece to be cut.

11. Laser beam cutting apparatus for implementing a method according to one of claims 1 to 10, comprising:
at least one laser generator for generating at least one laser beam;
at least one cutting nozzle with at least one laser beam inlet and at least one laser beam outlet;
at least one transparent or reflecting optical means of the multifocus type for focusing the said laser beam at several focal points; and
at least one source of assist gas containing hydrogen and at least one inert gas for the said laser beam and for feeding the said nozzle with the said assist gas.

12. Laser beam cutting apparatus for implementing a method according to one of claims 1 to 10, comprising :
at least one laser generator for generating at least one laser beam;
at least one cutting nozzle with at least one laser beam inlet and at least one laser beam outlet;
at least one transparent or reflecting optical means of the multifocus type for focusing the said laser beam at several focal points;
at least a first source of gas containing at least hydrogen;
at least a second source of gas containing at least one inert gas; and
gas mixing means for mixing the gas coming from the first gas source with gas coming from the second gas source so as to obtain an assist gas for the said laser beam containing hydrogen and at least one inert gas, the said assist gas feeding the said nozzle.
